(19) United States
(12) Patent Application Publication
(10) Pub. No.: US 2023/0254888 A1
(43) Pub. Date: Aug. 10, 2023

(54) TERMINAL, RADIO COMMUNICATION METHOD, AND BASE STATION

(71) Applicant: NTT DOCOMO, INC., Tokyo (JP)

(72) Inventors: Yuki Takahashi, Tokyo (JP); Shinya Kumagai, Tokyo (JP); Satoshi Nagata, Tokyo (JP)

(73) Assignee: NTT DOCOMO, INC., Tokyo (JP)

(21) Appl. No.: 18/004,994

(22) PCT Filed: Jul. 31, 2020
(86) PCT No.: PCT/JP2020/029556

§ 371 Date: Jan. 10, 2023

(51) Int. Cl. H04W 72/563; H04L 5/00; H04W 72/1268

(52) U.S. Cl. CPC H04W 72/563; H04L 5/0037; H04W 72/1268

(57) ABSTRACT

A terminal according to an aspect of the present disclosure includes: a receiving section that receives information related to a priority of a UL transmission; and a control section that controls, when a plurality of UL transmissions with different priorities overlap in a time domain, transmission processing of the plurality of UL transmissions, based on a carrier in which the plurality of UL transmissions is transmitted.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (e.g., referred to as “5th generation mobile communication system (5G),” “5G+ (plus),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### Technical Problem

### SUMMARY OF INVENTION

In future radio communication systems (for example, 5G, NR, and the like), it is assumed to include a mix of a plurality of services (also referred to as use cases, communication types, and the like) that are different in terms of communication requirement, such as high speed and large capacity (for example, enhanced Mobile Broad Band (eMBB)), massive machine type (for example, massive Machine Type Communication (mMTC), Internet of Things (IoT)), and ultra reliable and low latency (for example, Ultra Reliable and Low Latency Communications (URLLC)), for example.

For example, in Rel. 16 or later versions, it is studied that a priority is configured for each signal/channel to control communication, based on the priority configured for each signal/channel. For example, it is assumed that, when a plurality of signals/channels overlap, transmission/reception is controlled based on the priority of each of the signals/channels.

Meanwhile, such a case is also conceivable that a plurality of UL transmissions transmitted in respective different carriers (or cells, CCs) overlap in the time domain and the priorities of the plurality of UL transmissions are different from each other. Hence, it is not sufficiently studied how to control a plurality of UL transmissions different in priority when the UL transmissions are configured/scheduled in the same time domain in respective different carriers.

Thus, an object of the present disclosure is to provide a terminal, a radio communication method, and a base station with which one or more UL transmissions each supporting configuration of priority can be appropriately controlled.

### Solution to Problem

A terminal according to an aspect of the present disclosure includes: a receiving section that receives information related to a priority of a UL transmission; and a control section that controls, when a plurality of UL transmissions with different priorities overlap in a time domain, transmission processing of the plurality of UL transmissions, based on a carrier in which the plurality of UL transmissions is transmitted.

### Advantageous Effects of Invention

According to an aspect of the present disclosure, it is possible to appropriately control one or more UL transmissions each supporting configuration of priority.

### BRIEF DESCRIPTION OF DRAWINGS

FIG. 1A and FIG. 1B are each a diagram to show an example of UL transmission control based on priority;

FIG. 2 is a diagram to show another example of the UL transmission control based on priority;

FIG. 3 is a diagram to show an example of UL transmission control according to a zeroth option;

FIG. 4 is a diagram to show an example of UL transmission control according to a first option;

FIG. 5 is a diagram to show an example of UL transmission control according to a second option;

FIG. 6 is a diagram to show an example of UL transmission control according to third to sixth options;

FIG. 7 is a diagram to show an example of a schematic structure of a radio communication system according to one embodiment;

FIG. 8 is a diagram to show an example of a structure of a base station according to one embodiment;

FIG. 9 is a diagram to show an example of a structure of a user terminal according to one embodiment; and

FIG. 10 is a diagram to show an example of a hardware structure of the base station and the user terminal according to one embodiment.

### DESCRIPTION OF EMBODIMENTS

### <Traffic Type>

In future radio communication systems (for example, NR), it is assumed to include traffic types (also referred to as services, service types, communication types, use cases, and the like) such as further enhancement of a mobile broadband (for example, enhanced Mobile Broadband (eMBB)), machine type communication that enables massive simultaneous connections (for example, massive Machine Type Communication (mMTC), Internet of Things (IoT)), and ultra reliable and low latency communication (for example, Ultra-reliable and Low-Latency Communications (URLLC)). For example, in URLLC, lower latency and higher reliability than those in eMBB are required.

The traffic types may be identified in the physical layer, based on at least one of the following.
Logical channels having different priorities
Modulation and Coding Scheme (MCS) table (MCS index table)
Channel quality indication (CQI) table
DCI format
(Radio network temporary identifier (RNTI: System Information-Radio Network Temporary Identifier)) used for scrambling (mask) with a cyclic redundancy check (CRC) bit included in (added to) the DCI (DCI format)
RRC (Radio Resource Control) parameter
Specific RNTI (for example, an RNTI for URLLC, an MCS-C-RNTI, or the like)
Search space
Certain field (for example, a newly added field or reuse of an existing field) in DCI

Specifically, the traffic type of an HARQ-ACK for a PDSCH may be determined based on at least one of the following.
MCS index table used for determination of at least one of a modulation order, a target code rate, and a transport block size (TBS) of the PDSCH (for example, whether or not to use MCS index table 3)
RNTI used for CRC scrambling of DCI to be used for scheduling of the PDSCH (for example, whether to use a C-RNTI or an MCS-C-RNTI for the CRC scrambling)

The traffic type of an SR may be determined based on a higher layer parameter used as an identifier of the SR (SR-ID). The higher layer parameter may indicate whether the traffic type of the SR is eMBB or URLLC.

The traffic type of CSI may be determined based on configuration information related to CSI report (CSIreportSetting), DCI type used for trigger, a DCI transmission parameter, or the like. The configuration information, the DCI type, or the like may indicate whether the traffic type of the CSI is eMBB or URLLC. The configuration information may be a higher layer parameter.

The traffic type of a PUSCH may be determined based on at least one of the following.
MCS index table used for determination of at least one of a modulation order, a target code rate, and a TBS of the PUSCH (for example, whether or not to use MCS index table 3)
RNTI used for CRC scrambling of DCI to be used for scheduling of the PUSCH (for example, whether to use a C-RNTI or an MCS-C-RNTI for the CRC scrambling)

The traffic types may be associated with communication requirements (requirements such as latency or error rate, required conditions), data type (audio, data, or the like), and the like.

A difference between a URLLC requirement and an eMBB requirement may be that latency of URLLC is lower than latency of eMBB or that the URLLC requirement includes a reliability requirement.

For example, an eMBB requirement concerning user (U)-plane latency may include that downlink U-plane latency is 4 ms and uplink U-plane latency is 4 ms. In contrast, an URLLC requirement concerning U-plane latency may include that downlink U-plane latency is 0.5 ms and uplink U-plane latency is 0.5 ms. A URLLC requirement concerning reliability may include that the error rate of 32 bytes in U-plane latency of 1 ms is 10⁻⁵.

As enhanced Ultra Reliable and Low Latency Communications (eURLLC), advancement of reliability of traffic for unicast data is mainly under study. In the following, when URLLC and eURLLC are not distinguished, URLLC and eURLLC are simply referred to as URLLC.

### <Configuration of Priority>

For NR of Rel. 16 or later versions, it is studied to configure a plurality of levels (for example, two levels) of priority for certain signals/channels. For example, it is assumed to control communication (for example, transmission control at the time of collision and the like) by configuring separate priorities for respective signals or channels corresponding to respective different traffic types (also referred to as services, service types, communication types, use cases, and the like). This enables communication to be controlled by configuring different priorities for the same signal or channel according to service type or the like.

The priorities may be configured for at least one of signals (for example, UCI such as HARQ-ACK, reference signal, and the like), channels (PDSCH, PUSCH, PUCCH, and the like), reference signals (for example, channel state information (CSI), sounding reference signal (SRS), and the like), scheduling requests (SRs), and HARQ-ACK codebooks. The priorities may be separately configured for a PUCCH to be used for transmission of an SR, a PUCCH to be used for transmission of an HARQ-ACK, and a PUCCH to be used for transmission of CSI.

The priorities may be defined using a first priority (for example, high) and a second priority (for example, low), which is lower than the first priority. Alternatively, three or more kinds of priorities may be configured.

For example, the priorities may be configured for an HARQ-ACK for a PDSCH scheduled dynamically, an HARQ-ACK for a semi-persistent PDSCH (SPS PDSCH), and an HARQ-ACK for an SPS PDSCH resource. Alternatively, the priorities may be configured for HARQ-ACK codebooks corresponding to these HARQ-ACKs. Note that, in a case of configuring the priorities for PDSCHs, the priorities for the PDSCHs may be interpreted as priorities for HARQ-ACKs for the PDSCHs.

The priorities may be configured for a dynamic grant based PUSCH, configured grant based PUSCH, and the like.

A UE may be notified of information related to the priorities by a base station by using at least one of higher layer signaling and DCI. For example, a priority of a scheduling request may be configured by using a higher layer parameter (for example, schedulingRequestPriority). A priority of an HARQ-ACK for a PDSCH scheduled by DCI (for example, a dynamic PDSCH) may be notified by using the DCI. A priority of an HARQ-ACK for an SPS PDSCH may be configured by using a higher layer parameter (for example, HARQ-ACK -Codebook-indicator-forSPS) or may be notified by using DCI indicating activation of the SPS PDSCH. For P-CSI/SP-CSI transmitted in a PUCCH, a certain priority (for example, low) may be configured. In contrast, for A-CSI/SP-CSI transmitted in a PUSCH, a priority may be notified by using DCI (for example, DCI for trigger or DCI for activation).

A priority of a dynamic grant based PUSCH may be notified by using DCI that schedules the PUSCH. A priority of a configured grant based PUSCH may be configured by using a higher layer parameter (for example, priority). For a P-SRS/SP-SRS and an A-SRS triggered by DCI (for example, DCI format 0_1/DCI format 2_3), a certain priority (for example, low) may be configured.

### (Overlap of UL Transmissions)

When a plurality of UL signals/UL channels overlap (or collide), the UE may control UL transmissions, based on priorities.

A plurality of UL signals/UL channels overlapping may correspond to a case where the plurality of UL signals/UL channels overlap in terms of time resource (or time resource and frequency resource) or a case where the plurality of UL signals/UL channels overlap in terms of transmission timing. A time resource may be interpreted as a time domain. A time resource may be a unit of symbol, slot, subslot, or subframe.

A plurality of UL signals/UL channels overlapping in the same UE (for example, intra-UE) may mean that the plurality of UL signals/ UL channels overlap in at least the same time resource (for example, symbol). UL signals/UL channels colliding between different UEs (for example, inter-UE) may mean that a plurality of UL signals/UL channels overlap in the same time resource (for example, symbol) and frequency resource (for example, RB).

For example, when a plurality of UL signals/UL channels with the same priority overlap, the UE performs such control that the plurality of UL signals/UL channels are multiplexed to one UL channel for transmission (refer to FIG. TA).

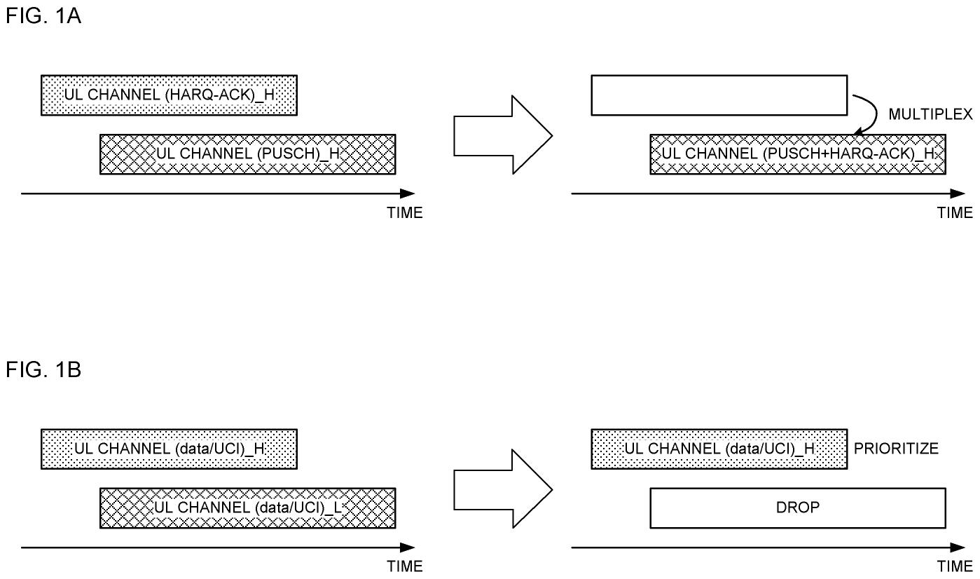

FIG. 1A shows a case where an HARQ-ACK (or a PUCCH for HARQ-ACK transmission) configured with the first priority (high) and UL data/UL-SCH (or a PUSCH for UL data/UL-SCH transmission) configured with the first priority (high) overlap. In this case, the UE multiplexes (or maps) the HARQ-ACK to the PUSCH to transmit both the UL data and the HARQ-ACK.

When a plurality of UL signals/UL channels of different priorities overlap, the UE may perform such control as to perform UL transmission with the high priority (for example, prioritizes the UL transmission with a high priority) and not to perform (for example, drops) UL transmission with the low priority (refer to FIG. 1B).

FIG. 1B shows a case where UL data/HARQ-ACK (or a UL channel for UL data/HARQ-ACK transmission) configured with the first priority (high) and UL data/HARQ-ACK (or a UL channel for UL data/HARQ-ACK transmission) configured with the second priority (low) overlap. In this case, the UE performs such control as to drop the UL data/HARQ-ACK with the low priority and transmit, by prioritizing, the UL data/HARQ-ACK with the high priority. Note that the UE may change (for example, postpone or shift) transmission timing of the UL transmission with the low priority.

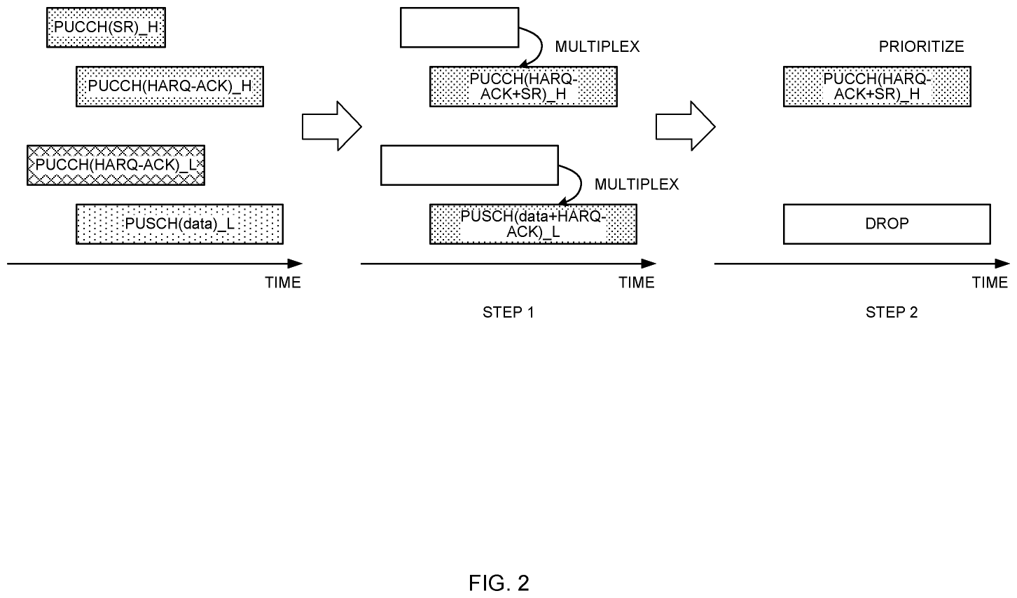

When more than two (or three or more) UL signals/UL channels overlap in the time domain, the transmissions may be controlled in two steps (refer to FIG. 2).

In step 1, one UL channel is selected on which UL signals to be transmitted in respective UL transmissions with the same priority are multiplexed. In FIG. 2, an SR (or a PUCCH for SR transmission) with the first priority (high) and an HARQ-ACK (or a PUCCH for HARQ-ACK transmission) may be multiplexed to a certain UL channel (here, the PUCCH for HARQ-ACK transmission). Similarly, an HARQ-ACK (or a PUCCH for HARQ-ACK transmission) with the second priority (low) and data (or a PUSCH for data/UL-SCH transmission) may be multiplexed to a certain UL channel (here, the PUSCH).

In step 2, the UE may perform such control for the UL transmissions with different priorities as to prioritize the UL transmission with the high priority for transmission and drop the UL transmission with the low priority. In FIG. 2, transmission of the PUCCH for SR and HARQ-ACK transmission with the first priority (high) may be prioritized, and the PUSCH for HARQ-ACK and data transmission with the second priority (low) may be dropped.

In this way, the UE can solve collision between a plurality of UL transmissions with the same priority in step 1 and solve collision between a plurality of UL transmissions with different priorities in step 2.

Meanwhile, such a case is also conceivable that a plurality of UL transmissions transmitted in respective different carriers (or cells, CCs) overlap in the time domain and the priorities of the plurality of UL transmissions are different from each other. It is not sufficiently studied how to control a plurality of UL transmissions in such a case.

For example, when UL channels/UL signals are scheduled in different inter-cell carriers supported by different RFs, transmission of each of the UL channels/UL signals is useful from a viewpoint of lower latency and spectrum efficiency.

The inventors of the present invention focused on presence of a case where a plurality of UL transmissions with different priorities are configured/scheduled in the same time domain in respective different carriers (or cells, CCs) and came up with the idea of an aspect of the present embodiment through study of control of the plurality of UL transmissions.

Embodiments according to the present disclosure will be described in detail with reference to the drawings as follows. The configurations described in respective embodiments may be employed individually, or may be employed in combination.

In the present disclosure, “A/B” may be interpreted as at least one of A and B, and “A/B/C” may be interpreted as at least one of A, B, and C.

In the following description, a description will be given by using, as examples, two levels, i.e., a first priority (high) and a second priority (low), as priorities of UL transmissions. However, the priorities are not limited to two levels. Three or more levels of priorities may be configured.

In the present disclosure, a UL transmission, a UL channel, and a UL signal may be interpreted interchangeably. In the present disclosure, a carrier, a cell, a CC, a BWP, and a band may be interpreted interchangeably. In the present disclosure, “transmitted” may be interpreted as scheduled, configured, or allocated.

### Embodiments

In the present embodiment, a description will be given of an example of UL transmission control in a case where a plurality of UL transmissions with different priorities overlap (or collide) in the time domain.

The UE may control UL transmissions, based on at least one of following option 0 to option 6, when a plurality of UL transmissions with different priorities are scheduled in, configured in, or allocated to the same time domain.

### <Option 0>

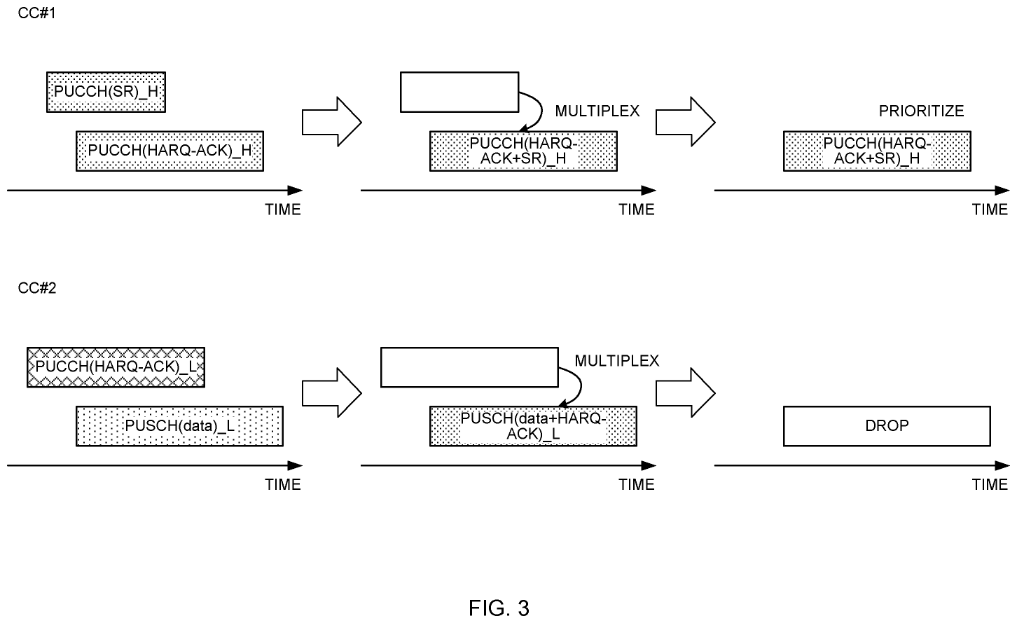

When the plurality of UL transmissions with different priorities overlap in the time domain, the UE may perform such control as to transmit only a first UL transmission with the first priority (for example, high) and drop a second UL transmission with the second priority (for example, low). The UE may transmit the first UL transmission and drop the second UL transmission not only when the plurality of UL transmissions are transmitted in the same cell but also when the plurality of UL transmissions are transmitted in different cells (for example, CC #1 and CC #2) (refer to FIG. 3).

FIG. 3 shows a case where four UL transmissions overlap in the same time domain in a plurality of cells (CC #1 and CC #2). Specifically, FIG. 3 shows a case where two UL transmissions with the same priority (here, high) overlap in CC #1 and two UL transmissions with the same priority (here, low) overlap in CC #2. In this case, the UE may control the transmissions in two steps.

In step 1, one UL channel is selected on which UL signals to be transmitted in respective UL transmissions with the same priority are multiplexed. In FIG. 3, an SR (or a PUCCH for SR transmission) with the first priority (high) and an HARQ-ACK (or a PUCCH for HARQ-ACK transmission) may be multiplexed to a certain UL channel (here, the PUCCH for HARQ-ACK transmission) in CC #1. Similarly, an HARQ-ACK (or a PUCCH for HARQ-ACK transmission) with the second priority (low) and data (or a PUSCH for data/UL-SCH transmission) may be multiplexed to a certain UL channel (here, the PUSCH) in CC #2.

Note that, when no such a plurality of UL transmissions with the same priority colliding in the time domain are included, it is only necessary to omit the operation of step 1. Step 1 may be limited to a plurality of UL transmissions transmitted in the same cell or may be applied to a plurality of UL transmissions transmitted in a plurality of respective cells.

In step 2, the UE may perform such control for the UL transmissions with different priorities as to prioritize the UL transmission with the high priority for transmission and drop the UL transmission with the low priority. In FIG. 3, transmission of the PUCCH for SR+HARQ-ACK transmission with the first priority (high) (CC #1) may be prioritized, and the PUSCH for HARQ-ACK+data transmission with the second priority (low) (CC#2) may be dropped.

In this way, it is possible to prioritize UL transmission with the first priority (high) being a high priority and also simplify the transmission processing of the UE.

### <Option 1>

When the plurality of UL transmissions with different priorities overlap in the time domain, the UE may perform such control as to transmit both (for example, simultaneously transmit) the first UL transmission with the first priority (for example, high) and the second UL transmission with the second priority (for example, low) in a case where a certain condition is satisfied. In a case where the certain condition is not satisfied, the UE may transmit the first UL transmission with the first priority (for example, high) and drop the second UL transmission with the second priority (for example, low), as in option 0.

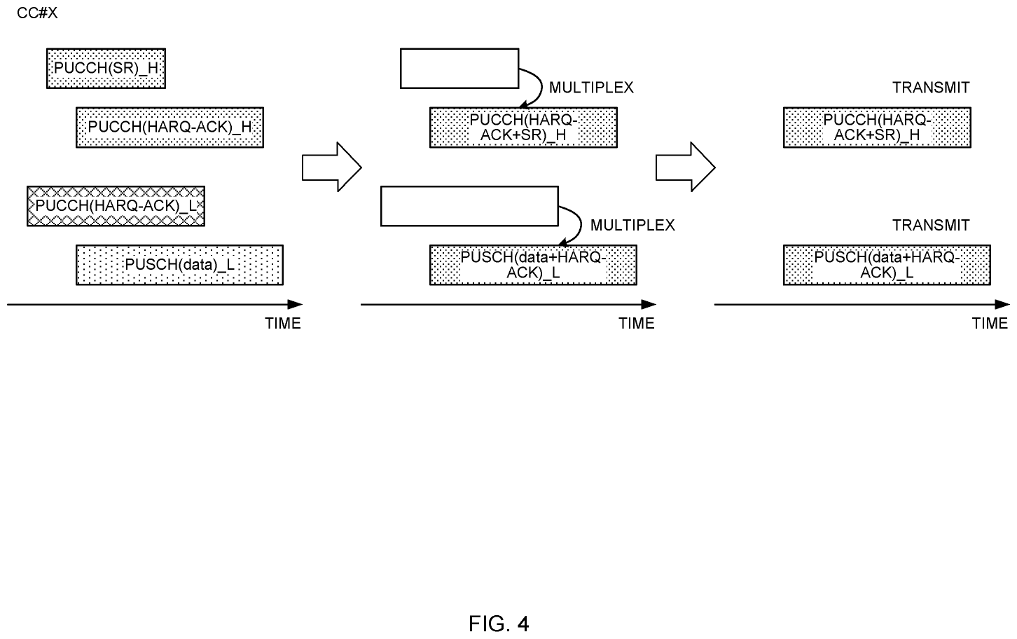

The certain condition may be that the first UL transmission with the first priority (for example, high) and the second UL transmission with the second priority (for example, low) are transmitted in a certain cell. Specifically, when the first UL transmission with the first priority (for example, high) and the second UL transmission with the second priority (for example, low) are transmitted in a specific cell, the UE may perform such control as to transmit both the first UL transmission with the first priority (for example, high) and the second UL transmission with the second priority (for example, low) (refer to FIG. 4).

The specific cell may be defined in a specification. Alternatively, the UE may be notified of information related to the specific cell by the base station by using higher layer signaling/DCI.

FIG. 4 shows a case where the first UL transmission with the first priority (for example, high) and the second UL transmission with the second priority (for example, low) are transmitted in the certain cell (here, CC #X). FIG. 4 shows a case where a plurality of UL transmissions with different priorities overlap in the same time domain in the specific cell (CC #X). Specifically, FIG. 4 shows a case where two UL transmissions with the first priority (for example, high) and two UL transmissions with the second priority (for example, low) (four UL transmissions in total) collide with each other in CC #X. In this case, the UE may control the transmissions in two steps.

In step 1, one UL channel is selected on which UL signals to be transmitted in respective UL transmissions with the same priority are multiplexed. FIG. 4 shows a case where an SR with the first priority (high) (or a PUCCH for SR transmission) is multiplexed to a PUCCH for HARQ-ACK transmission with the same priority. Similarly, FIG. 4 shows a case where an HARQ-ACK with the second priority (low) (or a PUCCH for HARQ-ACK transmission) is multiplexed to a PUSCH for data/UL-SCH transmission with the same priority.

Note that, when a plurality of UL transmissions with the same priority do not collide with each other, it is only necessary to omit operation of step 1.

In step 2, such control may be performed as to individually transmit a plurality of UL transmissions that overlap in the time domain in a specific cell and have different priorities. In FIG. 4, the PUCCH for SR+HARQ-ACK transmission with the first priority (high) (CC #1) is transmitted, and the PUSCH for HARQ-ACK +data transmission with the second priority (low) (CC#2) is also transmitted.

In this way, not only a UL transmission with a high priority but also a UL transmission with a low priority can be transmitted, which can hence reduce latency.

### <Option 2>

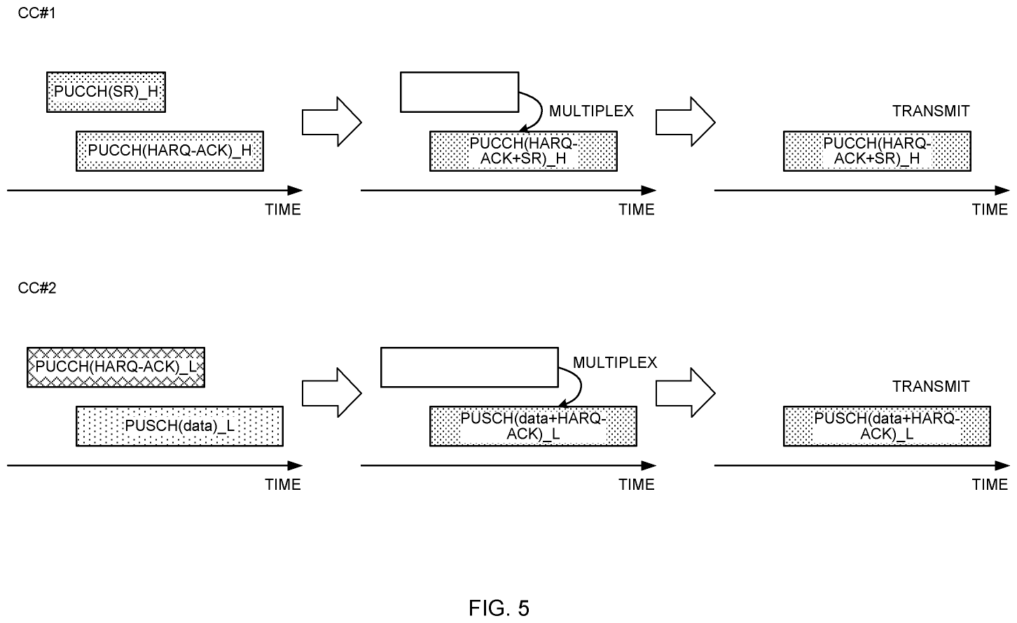

The certain condition may be that the first UL transmission with the first priority (for example, high) and the second UL transmission with the second priority (for example, low) are individually transmitted in different cells. Specifically, when the first UL transmission with the first priority (for example, high) and the second UL transmission with the second priority (for example, low) are transmitted in different cells, the UE may perform such control as to transmit both the first UL transmission with the first priority (for example, high) and the second UL transmission with the second priority (for example, low) (refer to FIG. 5).

FIG. 5 shows a case where four UL transmissions overlap in the same time domain in a plurality of cells (CC #1 and CC #2). Specifically, FIG. 5 shows a case where two UL transmissions with the same priority (here, high) overlap in CC #1 and two UL transmissions with the same priority (here, low) overlap in CC #2. In this case, the UE may control the transmissions in two steps.

In step 1, one UL channel is selected on which UL signals to be transmitted in respective UL transmissions with the same priority are multiplexed. FIG. 5 shows a case where an SR with the first priority (high) is multiplexed to a PUCCH for HARQ-ACK transmission in CC #1. Similarly, FIG. 5 shows a case where an HARQ-ACK with the second priority (low) is multiplexed to a PUSCH for data/UL-SCH transmission in CC #2.

Note that, when a plurality of UL transmissions with the same priority do not collide with each other, it is only necessary to omit operation of step 1. Step 1 may be limited to a plurality of UL transmissions transmitted in the same cell or may be applied to a plurality of UL transmissions transmitted in a plurality of respective cells. For example, step 1 may also be applied to a case where respective UL transmissions with the first priority are transmitted in CC #1 and CC #2 and respective UL transmissions with the second priority are transmitted in CC #1 and CC #2.

In step 2, such control may be performed as to individually transmit UL transmissions that overlap in the time domain in different cells and have different priorities. In FIG. 5, the PUCCH for SR+HARQ-ACK transmission with the first priority (high) (CC #1) is transmitted, and the PUSCH for HARQ-ACK+data transmission with the second priority (low) (CC#2) is also transmitted.

In this way, not only a UL transmission with a high priority but also a UL transmission with a low priority can be transmitted, which can hence reduce latency.

### <Option 3>

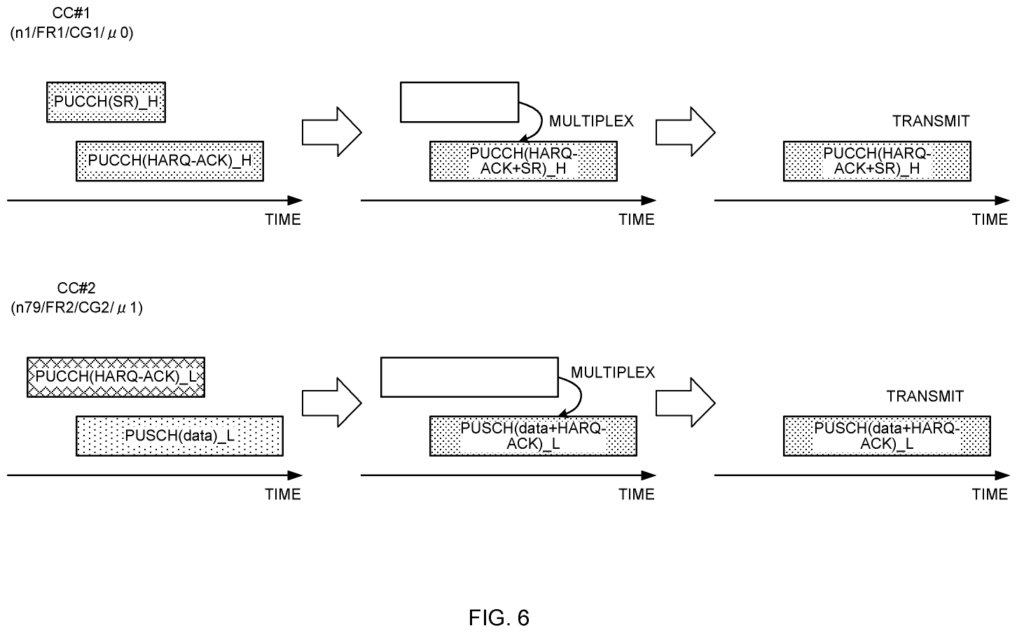

The certain condition may be that the first UL transmission with the first priority (for example, high) and the second UL transmission with the second priority (for example, low) are individually transmitted in cells with different frequency bands. Specifically, when the first UL transmission with the first priority (for example, high) and the second UL transmission with the second priority (for example, low) are transmitted in cells with different frequency bands, the UE may perform such control as to transmit both the first UL transmission with the first priority (for example, high) and the second UL transmission with the second priority (for example, low) (refer to FIG. 6).

FIG. 6 shows a case where four UL transmissions overlap in the same time domain in a plurality of cells (CC #1 and CC #2). Specifically, FIG. 6 shows a case where two UL transmissions with the same priority (here, high) overlap in CC #1 corresponding to a first frequency band (for example, n1) and two UL transmissions with the same priority (here, low) overlap in CC #2 corresponding to a second frequency band (for example, n79). In this case, the UE may control the transmissions in two steps.

Operation of step 1/step 2 may be controlled similarly to those in FIG. 5. The band (n1) of CC #1 and the band (n79) of CC #2 are examples, and the combination is not restrictive. The UE may be notified of/configured with information related to the bands to which the respective cells correspond, by the base station by using higher layer signaling or the like.

In this way, when UL transmissions with different priorities collide with each other in cells with different frequency bands, not only UL transmissions with a high priority but also UL transmissions with a low priority can be transmitted, which can hence reduce latency.

### <Option 4>

The certain condition may be that the first UL transmission with the first priority (for example, high) and the second UL transmission with the second priority (for example, low) are individually transmitted in cells with different frequency ranges (FRs). Specifically, when the first UL transmission with the first priority (for example, high) and the second UL transmission with the second priority (for example, low) are transmitted in cells with different FRs, the UE may perform such control as to transmit both the first UL transmission with the first priority (for example, high) and the second UL transmission with the second priority (for example, low) (refer to FIG. 6).

FIG. 6 shows a case where four UL transmissions overlap in the same time domain in a plurality of cells (CC #1 and CC #2). Specifically, FIG. 6 shows a case where two UL transmissions with the same priority (here, high) overlap in CC #1 corresponding to a first frequency range (for example, FR1) and two UL transmissions with the same priority (here, low) overlap in CC #2 corresponding to a second frequency range (for example, FR2). In this case, the UE may control the transmissions in two steps.

Operation of step 1/step 2 may be controlled similarly to those in FIG. 5. The frequency range (FR1) of CC #1 and the frequency range (FR2) of CC #2 are examples, and the combination is not restrictive. The UE may be notified of/configured with information related to the frequency ranges to which the respective cells correspond, by the base station by using higher layer signaling or the like.

In this way, when UL transmissions with different priorities collide with each other in cells with different frequency ranges, not only UL transmissions with a high priority but also UL transmissions with a low priority can be transmitted, which can hence reduce latency.

### <Option 5>

The certain condition may be that the first UL transmission with the first priority (for example, high) and the second UL transmission with the second priority (for example, low) are individually transmitted in cells of different cell groups (or cells belonging to different cell groups). Specifically, when the first UL transmission with the first priority (for example, high) and the second UL transmission with the second priority (for example, low) are transmitted in cells of different cell groups, the UE may perform such control as to transmit both the first UL transmission with the first priority (for example, high) and the second UL transmission with the second priority (for example, low) (refer to FIG. 6).

FIG. 6 shows a case where four UL transmissions overlap in the same time domain in a plurality of cells (CC #1 and CC #2). Specifically, FIG. 6 shows a case where two UL transmissions with the same priority (here, high) overlap in CC #1 belonging to a first cell group (for example, CG 1) and two UL transmissions with the same priority (here, low) overlap in CC #2 belonging to a second cell group (for example, CG 2). In this case, the UE may control the transmissions in two steps.

Operation of step 1/step 2 may be controlled similarly to those in FIG. 5. The cell group (CG 1) of CC #1 and the cell group (CG 2) of CC #2 are examples, and the combination is not restrictive. The UE may be notified of/configured with information related to the cell groups to which the respective cells belong, by the base station by using higher layer signaling/DCI or the like.

In this way, when UL transmissions with different priorities collide with each other in cells belonging to different cell groups, not only UL transmissions with a high priority but also UL transmissions with a low priority can be transmitted, which can hence reduce latency.

### <Option 6>

The certain condition may be that the first UL transmission with the first priority (for example, high) and the second UL transmission with the second priority (for example, low) are individually transmitted in cells with different numerologies (μ) (or configured with different numerologies). Specifically, when the first UL transmission with the first priority (for example, high) and the second UL transmission with the second priority (for example, low) are individually transmitted in cells to which different numerologies are used, the UE may perform such control as to transmit both the first UL transmission with the first priority (for example, high) and the second UL transmission with the second priority (for example, low) (refer to FIG. 6). A numerology may be interpreted as subcarrier spacing (SCS).

FIG. 6 shows a case where four UL transmissions overlap in the same time domain in a plurality of cells (CC #1 and CC #2). Specifically, FIG. 6 shows a case where two UL transmissions with the same priority (here, high) overlap in CC #1 to which a first numerology (μ=0) is used and two UL transmissions with the same priority (here, low) overlap in CC #2 to which a second numerology (for example, μ=1) is used. In this case, the UE may control the transmissions in two steps.

Operation of step 1/step 2 may be controlled similarly to those in FIG. 5. The numerology (μ=0) of CC #1 and the numerology (for example, μ=1) of CC #2 are examples, and the combination is not restrictive. The UE may be notified of/configured with information related to the numerologies applied to the respective cells, by the base station by using higher layer signaling/DCI or the like.

In this way, when UL transmissions with different priorities collide with each other in cells belonging to different cell groups, not only UL transmissions with a high priority but also UL transmissions with a low priority can be transmitted, which can hence reduce latency.

Note that, although a case where numerologies are configured for cells is described in the above description, this is not restrictive. A numerology to be used may be configured for each UL transmission (for example, each UL channel/UL signal). In this case, when a numerology configured/used for the first UL transmission with the first priority (for example, high) and a numerology configured/used for the second UL transmission with the second priority (for example, low) are different from each other and the first UL transmission and the second UL transmission are transmitted in different cells, the UE may perform such control as to transmit both the first UL transmission and the second UL transmission.

### <Variations>

The UE may switch between at least two options among the zeroth option to sixth option for application. For example, the UE may switch between the zeroth option and the first option (or at least one of the second option to sixth option) for application.

The UE may be notified of the option for the UE to use, by the base station by using higher layer signaling or the like. The UE may use at least one of the first option to the sixth option when the UE is configured with certain higher layer signaling, and the UE may use the zeroth option when the UE is not configured with the certain higher layer signaling. Alternatively, an option to be used by the UE may be defined in a specification.

The UE may report information related to an option that the UE can use (supports) to the base station as UE capability information (UE capability).

By switching between a plurality of options to use, it is possible to flexibly control UL transmissions according to the state of communication.

### <Determination of Priority>

The UE may determine/judge a priority of a UL channel/UL signal, based on certain information. For example, the UE may be notified of information related to the priority by the base station by using at least one of higher layer signaling and DCI.

The priority of the UL channel/UL signal may be associated with a parameter of the DCI (for example, a DCI format) corresponding to the UL channel/UL signal. The UE may judge the priority of the UL channel/UL signal scheduled, configured, or triggered by the DCI format, based on the DCI format. For example, a UL channel/UL signal corresponding to DCI format 0_1 may be configured with low, and a UL channel/UL signal corresponding to DCI format 0_2 may be configured with high.

A priority of a specific UL channel/UL signal may be defined in a specification. For example, either the first priority (for example, high) or the second priority (for example, low) may be used for A-CSI to be transmitted by using a PUCCH (or a PUCCH for transmitting A-CSI).

### <UL Transmission>

Each of the UL transmissions described above may be selected from among at least one of a dynamic grant based PUSCH, a configured grant based PUSCH, a PUCCH, a random access channel (PRACH), a PUSCH scheduled by a random access response (RAR), and a PUSCH for which transmission repetition is employed. Each of a plurality of UL transmissions that collide with each other in the time domain may be a UL transmission selected from among at least one of a dynamic grant based PUSCH, a configured grant based PUSCH, a PUCCH, a PRACH, a PUSCH scheduled by an RAR, and a PUSCH for which transmission repetition is employed.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

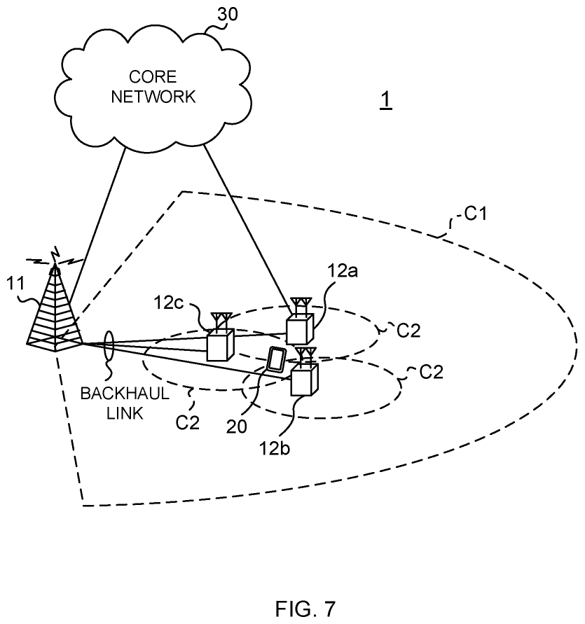

FIG. 7 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be also referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

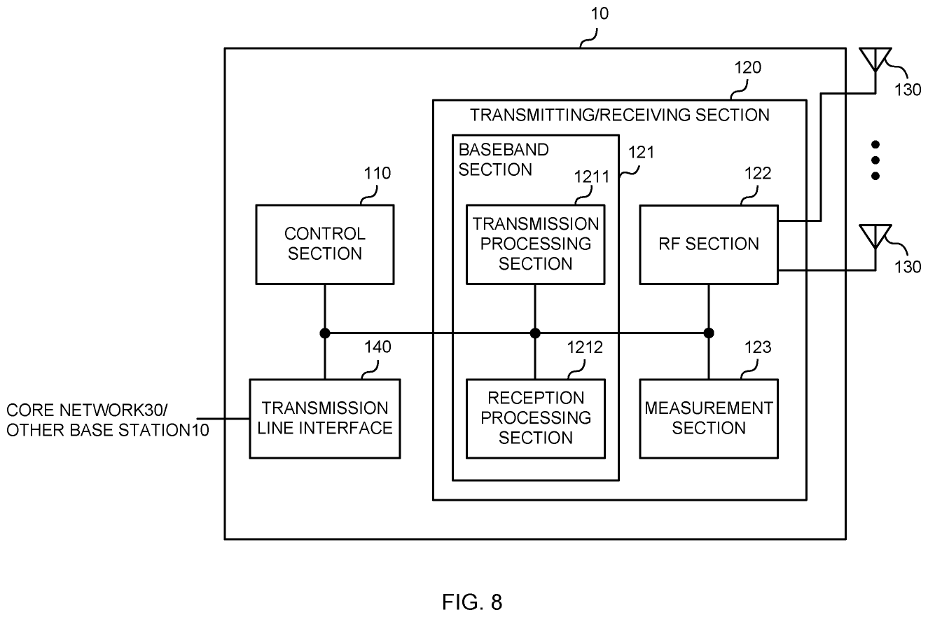

FIG. 8 is a diagram to show an example of a structure of the base station according to one embodiment. The base station 10 includes a control section 110, a transmitting/receiving section 120, transmitting/receiving antennas 130 and a transmission line interface 140. Note that the base station 10 may include one or more control sections 110, one or more transmitting/receiving sections 120, one or more transmitting/receiving antennas 130, and one or more transmission line interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the transmission line interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The transmission line interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the transmission line interface 140.

The transmitting/receiving section 120 may transmit information related to priorities of UL transmissions.

The control section 110 may control, when a plurality of UL transmissions with different priorities overlap in the time domain, reception processing for the plurality of UL transmissions, based on a carrier in which the plurality of UL transmissions is transmitted.

### (User Terminal)

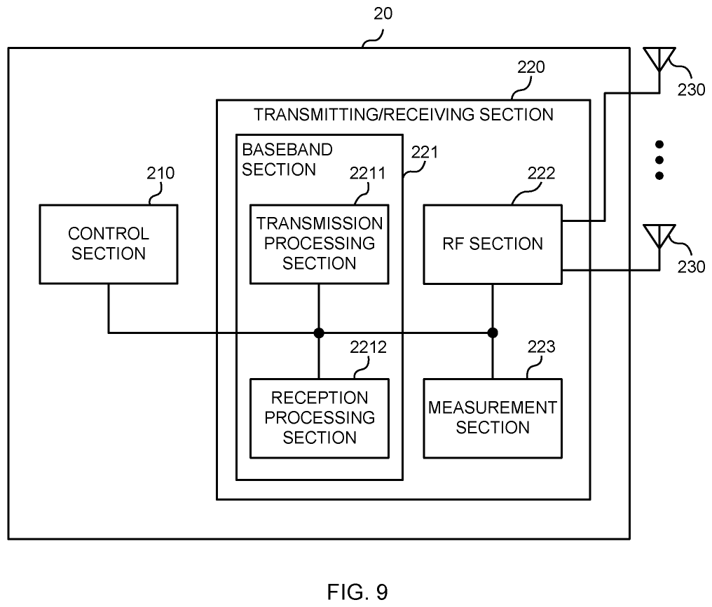

FIG. 9 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply a receiving process such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive information related to a priority of a UL transmission.

The control section 210 controls, when a plurality of UL transmissions of different priorities overlap in the time domain, transmission processing of the plurality of UL transmissions, based on a carrier in which the plurality of UL transmissions is transmitted.

The control section 210 may perform, when the plurality of UL transmissions are transmitted in a specific carrier, control to transmit each of the plurality of UL transmissions.

Alternatively, the control section 210 may perform, when the plurality of UL transmissions are transmitted in different carriers, control to transmit each of the plurality of UL transmissions. The different carriers may be different from each other in at least one of applied frequency band, applied frequency range, configured cell group, and configured subcarrier spacing.

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

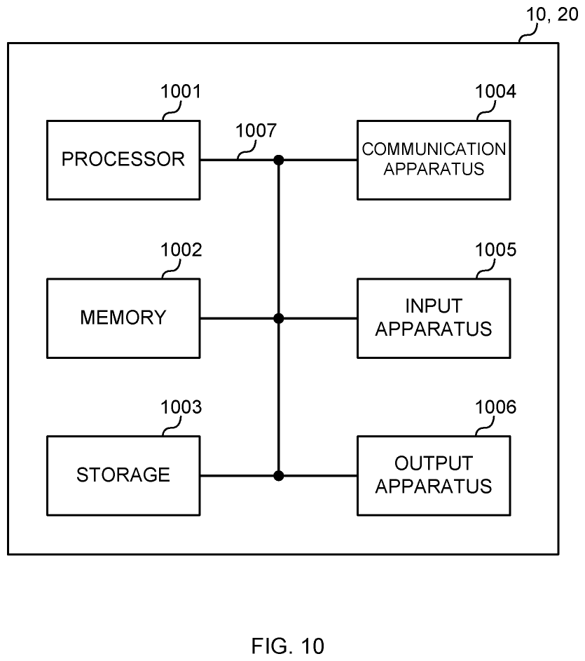

For example, a base station, a user terminal, and so on according to one embodiment of the present disclosure may function as a computer that executes the processes of the radio communication method of the present disclosure. FIG. 10 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAM), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### (Variations)

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a particular filter processing performed by a transceiver in the frequency domain, a particular windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),”a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. For example, since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be device mounted on a moving object or a moving object itself, and so on. The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor, and the like.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “side”). For example, an uplink channel, a downlink channel and so on may be interpreted as a side channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1.-6. (canceled)

7. A terminal comprising:
a transmitter that transmits capability information of the terminal regarding support of simultaneous transmission of a first uplink (UL) transmission with a first priority and a second UL transmission with a second priority;
a receiver that receives information regarding the first priority and information regarding the second priority; and
a processor that, when given higher layer signaling is configured, controls to simultaneously transmit the first UL transmission and the second UL transmission that overlap in a time domain.

8. The terminal according to claim 7, wherein when the given higher layer signaling is configured, the processor controls to simultaneously transmit the first UL transmission and the second UL transmission that overlap in the time domain, in cells with different frequency bands.

9. The terminal according to claim 7, wherein the first priority is different from the second priority.

10. The terminal according to claim 7, wherein the first UL transmission is a Physical Uplink Control Channel (PUCCH) transmission, and the second UL transmission is a Physical Uplink Shared Channel (PUSCH) transmission.

11. The terminal according to claim 7, wherein when the given higher layer signaling is not configured, the processor controls to perform the first UL transmission and to not perform the second UL transmission.

12. A radio communication method for a terminal, comprising:
transmitting capability information of the terminal regarding support of simultaneous transmission of a first uplink (UL) transmission with a first priority and a second UL transmission with a second priority;
receiving information regarding the first priority and information regarding the second priority; and
when given higher layer signaling is configured, controlling to simultaneously transmit the first UL transmission and the second UL transmission that overlap in a time domain.

13. A base station comprising:
a receiver that receives capability information of a terminal regarding support of simultaneous transmission of a first uplink (UL) transmission with a first priority and a second UL transmission with a second priority;
a transmitter that transmits information regarding the first priority and information regarding the second priority; and
a processor that, when given higher layer signaling is configured, controls reception processing for simultaneous transmission of the first UL transmission and the second UL transmission that overlap in a time domain.

14. A system comprising a terminal and a base station, wherein
the terminal comprises:
a transmitter that transmits capability information of the terminal regarding support of simultaneous transmission of a first uplink (UL) transmission with a first priority and a second UL transmission with a second priority;
a receiver that receives information regarding the first priority and information regarding the second priority; and
a processor that, when given higher layer signaling is configured, controls to simultaneously transmit the first UL transmission and the second UL transmission that overlap in a time domain, and
the base station comprises:
a receiver that receives the capability information;
a transmitter that transmits the information regarding the first priority and the information regarding the second priority; and
a processor that, when the given higher layer signaling is configured, controls reception processing for the simultaneous transmission of the first UL transmission and the second UL transmission that overlap in the time domain.
